(19) United States
(12) Patent Application Publication
(10) Pub. No.: US 2022/0355687 A1
(43) Pub. Date: Nov. 10, 2022

(54) ELECTRIC VEHICLE SERVICE EQUIPMENT

(71) Applicant: Oasis Charger Corporation, Oxford, CT (US)

(72) Inventors: Edward Gilchrest, Oxford, CT (US); Alexander E Borgestedt, New Haven, CT (US); Craig Bures, Prospect, CT (US); Andrew B Krystinik, Middlefield, CT (US); Elena Rae Abrams, New Haven, CT (US)

(21) Appl. No.: 17/739,059

(22) Filed: May 6, 2022

Related U.S. Application Data
(60) Provisional application No. 63/185,003, filed on May 6, 2021.

(51) Int. Cl. B60L 53/302; B60L 53/18; H02J 7/00

(52) U.S. Cl. CPC B60L 53/302; B60L 53/18; H02J 7/0042

(57) ABSTRACT

In accordance with one or more embodiments of the invention, an electric vehicle service equipment is presented, including an enclosure with one or more thermally conductive aluminum plates to passively dissipate board heat, a ratcheting retractor including a flexible cord attached to an electric charging cable, and a programmable logic device safety circuitry.

### CROSS-REFERENCE TO RELATED APPLICATIONS

This application claims the benefit of U.S. Provisional Application No. 63/185,003, filed May 6, 2021. The contents of the above-identified application are incorporated by reference in their entirety as if recited in full herein.

### BACKGROUND OF THE INVENTION

### Field of Invention

The inventions disclosed herein generally relate to electric vehicle service equipment, EVSE. More particularly, the inventions disclosed herein generally relate to AC charging devices and methods, e.g. for battery electric mobility equipment including without limitation cars, trucks, vans, bikes, scooters and other electric mobility devices (each an “EV” and collectively, “EVs”). More particularly, aspects of the inventions disclosed herein relate to ratcheting retractable power cable devices, safety circuitry, holsters, enclosures, programmable devices, charger mountings, patterns for bolt assembly, power cables, insulation, enclosures with passive heat dissipation and other aspects.

AC charging devices as disclosed herein may relate to a variety of types and levels of charging systems. One exemplary type of charging system is a 208-240 volt, Level 2, J1772 AC charging system which may be typical for many electric vehicles manufactured in North America and Europe and with an adaptor for other electric vehicles. Aspects of the invention may be applied to other and different charging systems including DC charging devices.

### Description of Related Art

Many different types of EVSE are known in the related arts, including EVSE related to Level 1 chargers, Level 2 chargers, and other systems.

### BRIEF SUMMARY OF EMBODIMENTS OF THE INVENTION

Aspects of the inventions may include electric vehicle servicing equipment comprising An enclosure including a circuit board, one or more thermally conductive aluminum plates, where at least one side of one of the thermally conductive aluminum plates is in contact with the circuit board to passively dissipate heat from the circuit board without the use of a coolant and without the use of air conditioning; a ratcheting retractor including a flexible cord attached to an electric charging cable, where the electric charging cable can retract into a reel fixed to the electric vehicle servicing equipment, the cord having ratchets that help to remove strain off the cord by reducing lateral tension and moment load on the electric charging cable; and a programmable logic device safety circuitry, the programmable logic device safety circuitry functioning without the use of software.

Aspects may also include where the enclosure includes two aluminum plates to conduct and disperse heat from the power circuit board, with thermal interface material between the two aluminum plates.

Aspects may also include where the enclosure is double insulated.

Aspects may also include a Level 2 electric vehicle charger.

Aspects may also include where the programmable logic device safety circuitry controls one or more safety relays.

Aspects may also include where one or more of the safety relays comprises a double relay, including a first relay and a second relay, and where the second relay will not close if any voltage is present.

Aspects may also include where the flexible cord is attached to a plastic molding causing the cord to bend vertically, and to not exceed the bend radius the cord.

Aspects may also include where the plastic molding is comprised of 2 identical clamshell pieces that fit together.

Aspects may also include a power control board performing safety circuit functions and network applications.

Aspects may also include a large flat surface for receiving branding or advertising.

Aspects may also include a heater for use in cold weather:

### BRIEF DESCRIPTION OF THE DRAWINGS

For a more complete understanding of various embodiments of the present invention, reference is now made to the following descriptions taken in connection with the accompanying drawings in which:

FIG. 1 illustrates an exemplary dual connector charger.

FIG. 2 illustrates internal components and assembly of a charger unit.

FIG. 3 illustrates views of a retractor mechanism.

FIG. 4 illustrates an exploded view of a retractor and enclosure.

FIG. 5 illustrates a top view of an exemplary retractor.

FIG. 6 illustrate multiple retractor pawl positions.

FIG. 7 illustrates a cross section of core thermal management.

FIG. 8 illustrates views of a cable clamp enclosure.

### DETAILED DESCRIPTION OF EMBODIMENTS OF THE INVENTION

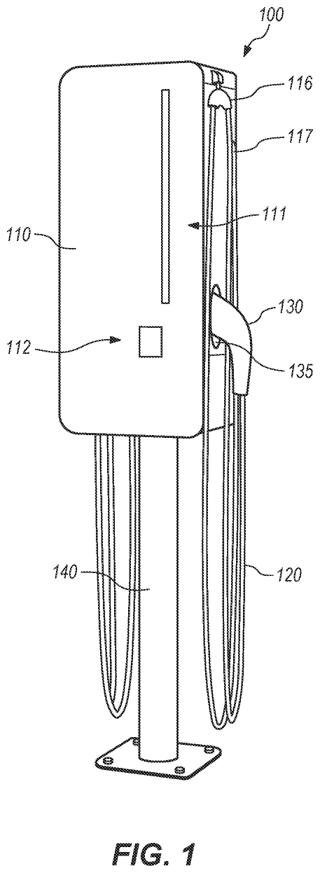

FIG. 1 illustrates an exemplary dual connector charger. Single connector chargers are also contemplated. Charger 100 is illustrated with enclosure 110, indicators and sensors 112, brandable door panel 111, cord management system 116, charger cord exit 117, charger cord 120, charger connector 130, cable plug 130, holster 135, and pedestal mount accessory 140. Enclosure 110 may be made of aluminum, for example an aluminum type 3R enclosure. Indicators and sensors 112 may include, for example, LED charger status indicators and RFID sensors. Enclosure 110 may be lockable. Brandable door panel 111 may include large substantially flat surfaces, suitable for branding, advertising, displays, etc.

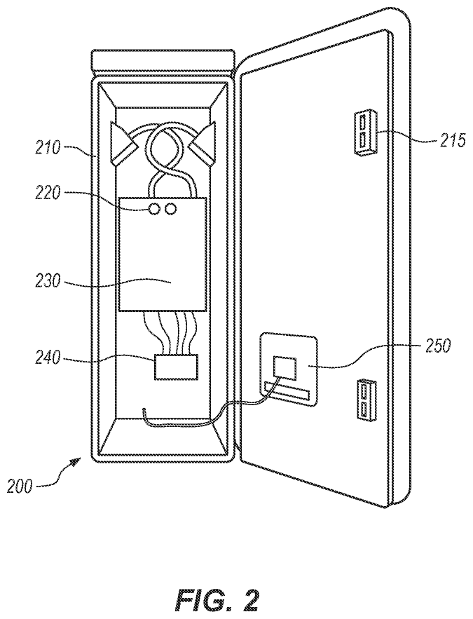

FIG. 2 illustrates internal components and assembly of a charger unit. FIG. 2 is illustrated including enclosure 200, with cam locks 210, cam latches 215, ethernet port 220, charger core 230, terminal blocks or breakers 240, and user interface and antenna assembly 250.

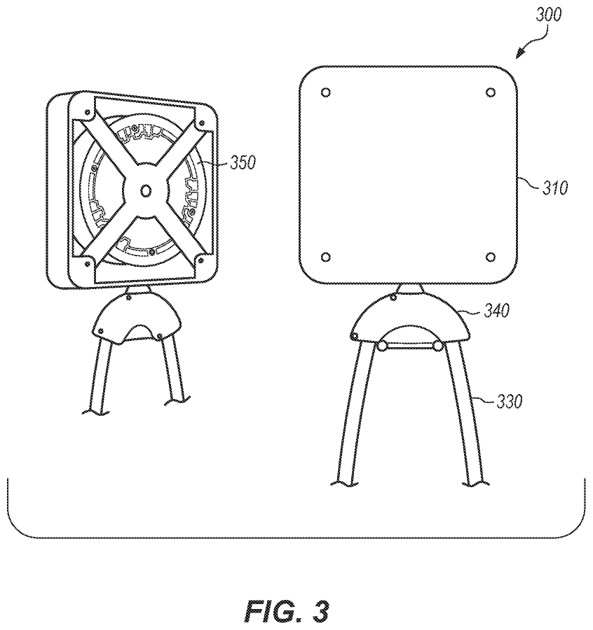

FIG. 3 illustrates views of a retractor mechanism. Retractor enclosure 300 is illustrated, with enclosure exterior 310, cable clamp enclosure 340, retractor mechanism 350, and charger cord 330.

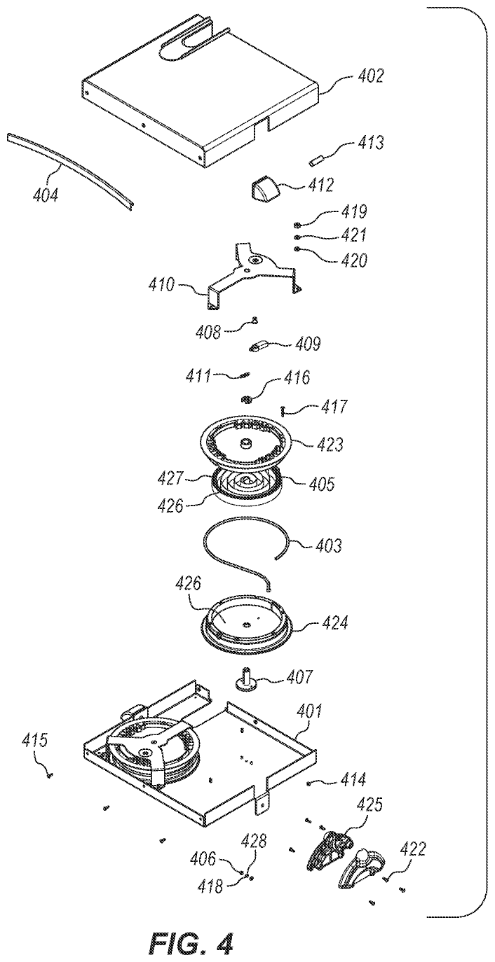

FIG. 4 illustrates an exploded view of a retractor and enclosure. FIG. 4 illustrates enclosure bottom 401, enclosure top 402, reel cord 403, seal 404, spring 405, pin 406, center post 407, shoulder rivet 408, retractor reel pawl 409, retractor reel bracket 410, spring 411, retractor guide 412, slotted spring pin 413, rivet 414, screw 415, retaining ring 416, screw 417, screw 418, nut 19, washer 420, washer 421, screw 422, retractor reel top enclosure 423, retractor reel bottom enclosure 424, cable clamp enclosure 425, grease 426, grease 427, and Loctite 428.

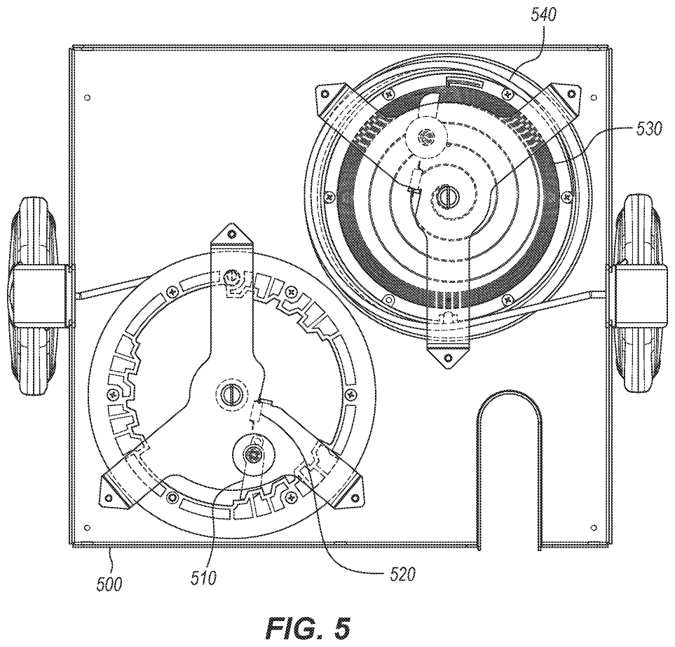

FIG. 5 illustrates a top view of an exemplary retractor. FIG. 5 illustrates retractor assembly 500, at 510 pawl provides lock up, at 520 a spring keeps pawl against ratchet teeth, at 530 constant force spring applies retraction force, and at 540 a preload is applied during assembly for full retraction.

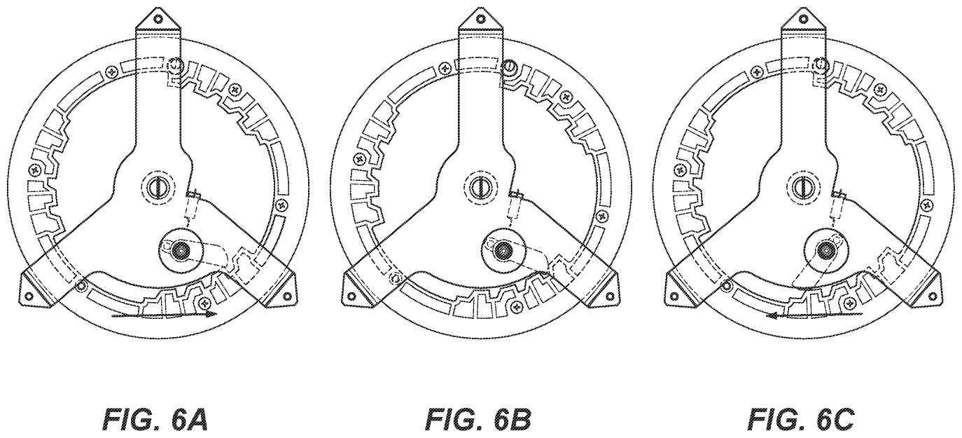

FIG. 6 illustrate multiple retractor pawl positions. FIG. 6A illustrates retractor pawl position during extension, FIG. 6B illustrates retractor pawl position during lock up, and FIG. 6C illustrates retractor pawl position during retraction. Arrows indicate direction of rotation.

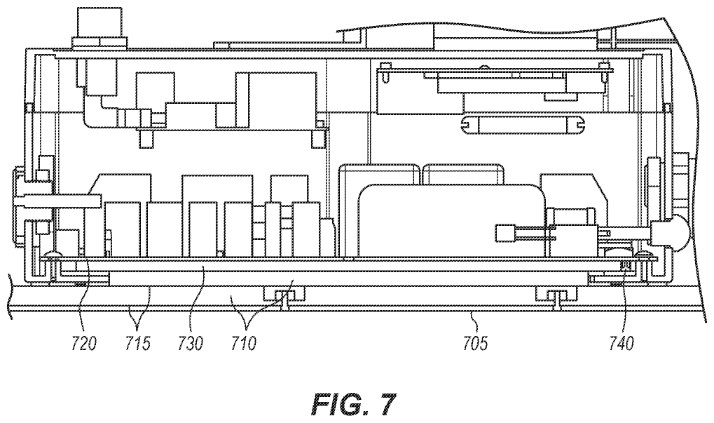

FIG. 7 illustrates a cross section of core thermal management. As illustrated in FIG. 7, core thermal management includes a back face of enclosure 705, aluminum plates 710 to conduct and disperse heat from power PCB 720, thermal interface material 715 spread between aluminum faces, thermally conductive and electrically insulated soft pad 730. A thickness of soft pad 730 is preferably greater than the max protrusion from the back of the power PCB or power board 720. Also illustrated in FIG. 7 is spacer 740 to fill a gap.

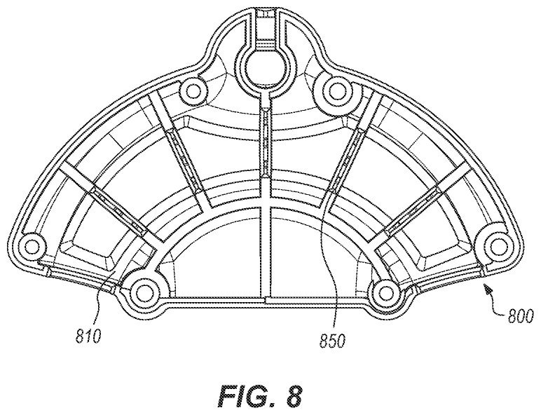

FIG. 8 illustrates views of a cable clamp enclosure. FIG. 8 includes molded portion 800, with surfaces 810 and clamping ribs 850.

Retractable Charging Cable Device Aspects of the invention include retractable charging cable devices. A nylon cord or flexible cord made of other material, attached to an electric charging cable, retracts into a reel that may be fixed at the top or on the side of a charging station. The cord may have ratchets that help take the strain off the cord so that at different stages of its extension it does not pull the cord and cable back toward the charging station. This reduces the amount of lateral tension and moment load on the cable as well as on the plug at the end of the cable which connects into an EV port or on any adaptor attached to such plug before connecting it to the EV port.

The cord may be attached to a plastic molding designed to cause the cord to bend vertically, but not so much that it would exceed the bend radius of the cord. The bend helps lift the charge cable off the ground, reducing the risk of tripping, electrical arcing from handles dropped in, e.g., puddles, and wear and tear. The molding assists in holding the bend.

The retractor system reduces tension on the charging cord. Adaptors must often be used to convert a charging station's standard J1772 design for cars that require a different plug such as a Tesla, Honda Nissan, or other EV, and this adaptor extends the plug from the car and can increase lateral tension on the vehicle charging port. This tension can pull the conductors out of alignment, reducing the continuity of the electric charge flowing through the conductors, which may cause excessive heat, premature wear and tear, or failure in the form of melting or contact welding (a known issue with some adaptors).

The molded piece that holds the retractor reel may be comprised of 2 clamshell pieces that are identical and that fit together so only one molding is required for manufacturing, saving money in the cost of tooling, preparing injection molds and fabrication.

The cord may be retracted substantially into the case, disappearing from view for both aesthetic reasons and to protect it from the elements and from damage. The ratcheting of the cord is also designed to reduce pressure on the electrical cable and the plug. The retractable hose may work with a recoiling action for retraction, similar to the cord mechanism in a set of window blinds. The molded plastic may have a bend in the mold to articulate the cable so it lays substantially flat and doesn't hang, helps to give the cord shape, and helps to give the cord a tighter bend than it would otherwise have. The but end of the nylon cord may fit into a pocket, may have an angle of clamp in a vertical position, causing it to drop straight down, e.g. next to the body of a charging station. When a plug, adaptor or other vehicle connector is pulled away from an EV, a point of leverage may be created, and a connector may be pulled on a far side away from the electrical connectors, reducing continuity and potentially causing arcing; the present assembly extends the plug away from a vehicle so less tension may be on an adaptor, helping to avoid arcing.

Safety Relays Novel use in a Level 2, double pole configuration. The United States generally uses a double pole system, in contrast to a 3 phase US system or a single phase commonly used in Europe. Often in the U.S., two electromechanical relay poles to open and close the circuit are required. May be in a 240V configuration.

Aspects of the invention include a second set of relays in series with the main components. The second set provides a first make-last break system. When the first relay makes the connection, there is no load on the system and the second relay remains open. When the first relay closes, the circuit checks for electric current being present. If there is any voltage present, the second relay will not close.

If there is no voltage, the second relay then closes. Aspects of the invention include the ability not to close the second relay, avoiding a safety risk. If the second relay were welded or fails closed, thereby providing for a continuous current of electricity, the first relay would not close or would open up, avoiding a safety risk. The typical failure of a relay in an EV charging station is a weld in the closed position. UL calls for a stuck relay test, reflecting that this may be a common occurrence; in the invention the double relays in a double pole system address the risk of a stuck relay.

Terminal Blocks Aspects may include terminal blocks. Terminal blocks accept wires, e.g. from a facility's A/C power supply. Aspects of the invention have very large terminal blocks that can accept a wide range of wire gauges for use with a wide range of feed wire (e.g., a 7 gauge wire for a 30 amp current or a 3/0 gauge wire for a 240 amp current).

The terminal blocks allow for the installation of big wires for high amperage systems, and also smaller wires that carry lower currents. It also facilitates replacing charging stations that require one gauge of wires with charging stations that require a different gauge of wires according to aspects of the invention, avoiding the need for rewiring.

The blocks may also accept jumpers (a connector that stands between two terminal blocks; one wire comes in and two go out), thus reducing the number of wires coming into the terminal blocks. In some embodiments, circuit breakers replace terminal blocks.

The assembly on which the terminal blocks may sit can be replaced by miniature circuit breakers that can permit de-energizing the charging station without requiring the time and expense of going back to a utility room to disconnect the electrical current.

Holster The holster, the socket present, for example, on the side or front of a charging station, is where the cable plug is inserted when not in use and inserted in the EV. It fills a penetration in the side of the charger.

The angle of the holster may be set so that the handle is in an upright fashion or at an angle that allows the connector to be removed easily and that may allow the cable to hang down neatly in line with the charger. The holster enclosure may be made of 5VA material, the flame rating based on a UL standard. This high burn rating has been used, consistent with the enclosure.

The holster may be designed so that it can be removed and replaced with, e.g. a stainless steel cutout into which a socket may be mounted in order to accommodate those utilities and municipalities that wish to accommodate EV users who carry their own cables to connect their EVs to charging stations. Where a charging station has two penetrations for a holster, one of the holsters could hold a plug and the other could be replaced by the socket permitting both traditional charging with a cable and plug mounted on the charging station and the alternate form of charge for EV users who carry their own cables and plugs.

The holster may be made of a non-marring, stainless, non-painted material that avoids corrosion and protects the body from wear and tear when the handle is removed and replaced into the charging station. In cases where the holster may be removed and replaced with a socket, a trim ring may be fit around the holster penetration providing protection from the plug inserted by an EV user that carries his or her own cable and plug.

External Enclosure Aluminum may be used in lieu of steel or plastic to create the body of the external enclosure of the device. This protects the charger core from damage from external shocks and helps to avoid rust and other wear and tear. The enclosure may be aluminum. This is inherently fire resistant. The holster may be part of the enclosure and may be 5VA to maintain an overall 5VA rating for the enclosure. This is for the outer enclosure. The inner, core enclosure, may also be also 5VA rated. For cold applications, one or more heaters may be incorporated, in order to improve efficiency or effectiveness.

Safety Circuitry Solid state or other circuitry may be used in lieu of software, permitting the charging station to be programmed without the risk of introducing bugs. Programmable hardware and fixed hardware is envisioned. Programmable hardware or fixed hardware helps to avoid software bugs that can plague systems dependent on software. Programmable Logic Devices, PLDs, may be complex, and may be reprogrammable. Such PLDs serve as alternatives to functionality provided by microprocessors, which may be cheaper but may also rely on software and thus be more susceptible to safety bugs or software bugs.

A power control board may be used to perform all UL safety circuit functions and other network applications. A property owner with a charging station can install or substitute other controllers interchangeably without needing to recalibrate the UL function or make other costly changes. In contrast to existing charging stations that are linked to a proprietary or exclusive control device, charging stations of the current invention may be agnostic to the controller that connects to the network or cloud. As such, property owners with a charging station have flexibility in choosing a controller. Controllers may be cloud-connected, may be cloud-controlled.

Mounting the Charger A wall mount bracket has a lip at the bottom that may allow the charging station to be balanced and installed by a single individual who can screw in bolts in the top and bottom without assistance.

The bottom of the charging station or a pedestal on which the charging station sits has a variety of bolt patterns to facilitate mounting on a separate pedestal or a preexisting concrete base, other columnar base or other support that may have been used to support another charging station.

Cable A multi-conductor cable may be used instead of a single conductor per pole. This allows the cable to be thinner and more flexible for present power requirements. May be revenue-grade power meter certified. May include power monitoring and measuring capabilities.

Insulation To meet UL standards and to enhance safety, the insulation may be combined with a current imbalance detection system. Particularly on a Level 2 product with double connectors, if there is an imbalance, e.g. of as little as 20 milliamps, it may open the relays and stop electricity from flowing.

A polycarbonate, double insulated enclosure may be used inside a weather-rated decorative enclosure, providing electrical insulation and meeting essential UL safety requirements. The inner core could function on its own without the outer enclosure. A potential alternative to double insulated would be to detect ground continuity or not.

The core may be bonded to an aluminum transfer structure. At full current, a lot of heat may be dissipated within the core. In a plastic box it may be difficult to cool the components. By coupling the heat producers to the bottom of the plastic enclosure with two e.g. aluminum heat spreaders, one inside the core and one inside the external enclosure, heat may be dissipated. An enclosure can be used as a heat sync, to dissipate the heat passively rather than actively. Passive heat dissipation may thus be effectuated without the use of coolant and without the use of air conditioning.

5G Transmitter A 5G transmitter located inside the charger in order to provide 5G connectivity for anybody in the vicinity of the charger. Chargers may be situated, for example, in parking lots and garages of office buildings, multi-family apartment buildings, national and state parks, hospitals, university campuses, and retail store parking areas, among others.

Retractor Cord Box The retractor cord box may be situated on or near the top of the charger to leave room for an aerial.

Fan and Filter System A fan and filter system may be incorporated in the charger to filter out particulate matter (to help clean the air around the charger (by definition, our chargers are around vehicles that emit)).

Temperature Detector A temperature detector device in the hose plug to detect unsafe temperature levels which would shut down the flow of electricity.

Carbon Capture Device A carbon capture device may be incorporated into the invention.

As will be realized, the systems and methods disclosed herein are capable of other and different embodiments and its several details may be capable of modifications in various respects, all without departing from the invention as set out in the appended claims. Accordingly, the drawings and description are to be regarded as illustrative in nature and not in a restrictive or limiting sense with the scope of the application being indicated in the claims.

What is claimed is:

1. Electric vehicle servicing equipment comprising:
An enclosure including a circuit board, and one or more thermally conductive aluminum plates, where at least one side of one of the thermally conductive aluminum plates is connected to the circuit board to passively dissipate heat from the circuit board without the use of a coolant and without the use of air conditioning;
a ratcheting retractor including a flexible cord attached to an electric charging cable, where the electric charging cable can retract into a reel of the electric vehicle servicing equipment, the cord having ratchets that help to remove strain off the cord by reducing lateral tension and moment load on the electric charging cable; and
a programmable logic device safety circuitry, the programmable logic device safety circuitry functioning without the use of software.

2. The electric vehicle servicing equipment of claim 1, where the enclosure includes two aluminum plates to conduct and disperse heat from the circuit board, with thermal interface material between the two aluminum plates.

3. The electric vehicle servicing equipment of claim 1, where the enclosure is double insulated.

4. The electric vehicle servicing equipment of claim 1, comprising a Level 2 electric vehicle charger.

5. The electric vehicle servicing equipment of claim 1, where the programmable logic device safety circuitry controls one or more safety relays.

6. The electric vehicle servicing equipment of claim 5, where one or more of the safety relays comprises a double relay, including a first relay and a second relay, and where the second relay will not close if any voltage is present.

7. The electric vehicle servicing equipment of claim 1, where the flexible cord is attached to a molding causing the cord to bend vertically, and to not exceed the bend radius the cord.

8. The electric vehicle servicing equipment of claim 1, where the molding is comprised of 2 identical clamshell pieces that fit together.

9. The electric vehicle servicing equipment of claim 1, including a power control board performing safety circuit functions and network applications.

10. The electric vehicle servicing equipment of claim 1, including a large flat surface for receiving branding or advertising.

11. The electric vehicle servicing equipment of claim 1, including a heater for use in cold weather.
